(19) United States
(12) Patent Application Publication
(10) Pub. No.: US 2005/0063547 A1
(43) Pub. Date: Mar. 24, 2005

(54) Standards-compliant encryption with QKD

(76) Inventors: Audrius Berzanskis, Cambridge, MA (US); Paul Jankovich, Northboro, MA (US)

Correspondence Address: MAGIQ TECHNOLOGIES, INC, 171 MADISON AVENUE, SUITE 1300, NEW YORK, NY, 10016-5110, US

(21) Appl. No.: 10/837,775

(22) Filed: May 3, 2004

Related U.S. Application Data
(63) Continuation-in-part of application No. 10/665,612, filed on Sep. 19, 2003.

(51) Int. Cl. H04L 9/00

(52) U.S. Cl. 380/278

(57) ABSTRACT

An encryption system and method that utilizes quantum key distribution (QKD) and that is compliant with industry and/or governmental standards for encryption is disclosed. One example embodiment of the system includes first and second transmitters/receivers operatively connected to respective first and second encryption/decryption (e/d) processors. The e/d processors are connected to a classical key distribution system as well as to a QKD system. The QKD system symmetrically provides quantum keys qi to the e/d processors, and the classical encryption system symmetrically provides classical keys ci to the e/d processors. The e/d processors then form session keys ki via the operation ki=ci XOR qi. The session keys are then used to encrypt and decrypt plaintext messages sent between two transmitting/receiving stations.

### RELATED APPLICATIONS

This patent application is a continuation-in-part of U.S. patent application Ser. No. 10/665,612, entitled “FIPS-compliant encryption system with quantum key distribution,” filed on Sep. 25, 2003, which patent application is incorporated herein by reference.

### FIELD OF THE INVENTION

The present invention relates to encryption systems and methods that satisfy industry and/or government standards, such as the Federal Information Processing Standard (FIPS) of the United States, and more particularly relates to such systems and methods that utilize quantum key distribution (QKD).

### BACKGROUND OF THE INVENTION

Federal Information Processing Standards (FIPS)

Technologies typically have standards to which apparatus must or should conform. The standards are usually proffered by industry groups and/or by various government agencies. For example, in the United States, under the Information Technology Management Reform Act (Public Law 104-106), the Secretary of Commerce approves standards and guidelines developed by the National Institute of Standards and Technology (NIST) for Federal computer systems. These standards and guidelines are issued by NIST as Federal Information Processing Standards (FIPS) for government-wide use. NIST develops FIPS when there are compelling Federal government requirements, such as for security and interoperability, and there are no acceptable industry standards.

The FIPS governing the security requirements for cryptographic equipment (“modules”) is set forth in FIPS Publication 140-2. This standard specifies the security requirements that need to be satisfied by a cryptographic module utilized within a security system protecting sensitive but unclassified information. The standard provides for increasing qualitative levels of security ranked as Levels 1 through 4. These levels are intended to cover the wide range of potential applications and environments in which cryptographic modules may be employed. The security requirements cover areas related to the secure design and implementation of cryptographic module ports and interfaces, roles, services and authentication, finite state models, physical security, operation environment, cryptographic key management, electromagnetic interference/compatibility (EMI/EMC), self tests; design assurance, etc.

The Cryptographic Module Validation Program (CMVP) validates cryptographic modules to the FIPS 140-2 standard, as well as to other cryptography-based standards. The CMVP is a joint effort between NIST and the Communications Security Establishment (CSE) of the Canadian Government. Products validated as conforming to the FIPS 140-2 standard are accepted by the Federal agencies of the U.S. and Canada for protecting “sensitive information” (U.S.) or “designated information” (Canada). The goal of the CMVP is to promote the use of validated cryptographic modules and provide Federal agencies with a security metric to use in procuring equipment containing validated cryptographic modules.

In the CMVP, vendors of cryptographic modules use independent accredited testing laboratories (e.g., Atlan Laboratories, McLean, Virginia) to have their modules tested. National Voluntary Accreditation Program (NVLAP) accredited laboratories perform cryptographic module compliance/conformance testing.

Though FIPS are ostensibly for the procurement of equipment by the government, the practical effect is that private industry also looks to the FIPS standards when purchasing equipment. This is, in part, because NIST collaborates with national and international standards committees, users, industry groups, consortia and research and trade organizations to develop the standards. Thus, it is to a company's business advantage that their equipment satisfies FIPS even if it has no intention of selling equipment to the government.

Virtual Private Networks (VPNs)

A virtual private network (VPN) is a secure private network connection built on top of a publicly accessible communication structure, such as the Internet or the public telephone network. For security reasons, data sent over a VPN is typically encrypted. Further, other measures such as digital certificates, access control, and strong user authentication are employed to enhance system security. Prior to VPNs, users had to contact one another by establishing computer connections via dial-up over telephone lines into a remote access server (RAS).

FIG. 1 is a schematic diagram of a prior art commercially available standards-compliant VPN 20 that forms an encrypted link between two transmitting/receiving stations Alice and Bob. VPN 20 includes two encryption/decryption (e/d) processors 24 and 26. Alice is connected to e/d processor 24 via an Ethernet section 30. Bob is connected to e/d processor 26 via an Ethernet section 32. The e/d processors 24 and 26 are connected via a VPN link 40 (e.g., the Internet).

In the operation of VPN 20, Alice transmits a plaintext signal 50 over Ethernet link 30 to e/d processor 24. Plaintext signal 50 is encrypted at e/d processor 24 to form an encrypted signal 54, which is transmitted over VPN link 40 to e/d processor 26, where it is decrypted and converted back into a plaintext signal 50′. Plaintext signal 50′ then travels from e/d processor 26 over Ethernet link 32, and is received by Bob.

An example of a standards-compliant VPN 20 that satisfies FIPS is the DiamondTeck™ VPN, available from Cryptek, Inc., Sterling, Va.

QKD and Link Encryption

FIG. 2 is a schematic diagram of a prior art VPN 100 for performing encrypted communication between Alice and Bob using QKD. VPN 100 includes two encryption/decryption (e/d) processors 106 and 110. Alice is connected to e/d processor 106 via Ethernet section 116. Bob is connected to e/d processor 110 via Ethernet section 120. The e/d processors 106 and 110 are connected via VPN link 130.

Included in VPN 100 is a QKD system 150 having a quantum channel 156 connecting two QKD stations 160 and 164. The QKD station 160 is connected to e/d processor 106 via a connection 170, and QKD station 164 is connected to e/d processor 110 via a connection 172.

In the operation of VPN 100, a quantum key 178 is securely exchanged between QKD stations 160 and 164 using any one of a number of known quantum cryptographic methods. Once the key is securely exchanged, it is distributed to e/d processors 106 and 110 via signals 180 and 184 from QKD stations 160 and 164, respectively. This is referred to as symmetric key distribution. The quantum key is then used to encrypt a plaintext Ethernet signal 200 from Alice at e/d processor 106 to form encrypted signal 202 and send it over VPN link 130, where it is decrypted at e/d processor 110 to form decrypted signal 200′, which is sent to Bob over Ethernet section 130.

FIPS and QKD Encryption Systems

System 100 of FIG. 2 is not compliant to encryption standards such as FIPS because such standards have not yet been developed for the nascent field of quantum cryptography. It is anticipated that establishing such standards will take many years. This is a major problem for companies that seek to enter the cryptography market and sell QKD-based encryption systems since, as mentioned above, both government and non-government organizations look to standards such as FIPS as a governmental “seal of approval” when making purchasing decisions.

### SUMMARY OF THE INVENTION

A first aspect of the invention is a standards-compliant QKD-based encryption system. The system includes first and second transmitting/receiving stations operatively coupled to respective first and second operatively coupled encryption/decryption (e/d) processors. The system also includes first and second operatively coupled QKD stations respectively operatively connected to the first and second e/d processors. The QKD stations are adapted to exchange quantum keys qi between the first and second QKD stations and provide the quantum keys to the first and second e/d processors. The system further includes first and second operatively coupled standards-compliant classical key exchange stations respectively operatively connected to the first and second e/d processors. The classical key exchange stations are adapted to exchange classical keys ci and provide the classical keys to the first and second e/d processors. The e/d processors are adapted to receive a signal from one of the transmitting/receiving stations, encrypt the signal using an session key ki formed in the e/d processors via the operation ki=ci XOR qi, and transmit the encrypted signal to the other transmitting/receiving station.

In one embodiment of the first aspect of the invention, the standard being met is FIPS.

A second aspect of the invention is a standards-compliant encryption system. The system includes first and second transmitters/receivers operatively connected through a standards-compliant classical encryption system and operatively connected to a QKD system. The QKD system and the classical encryption system respectively provide classical keys ci and quantum keys qi to e/d processors, which then form session keys ki via the operation ki=ci XOR qi. The session keys are then used to encrypt and decrypt a plaintext signal from one of the first and second transmitters/receivers.

A third aspect of the invention is a method of transmitting an encrypted signal between first and second transmitting/receiving stations. The method includes sending a first plaintext signal from the first transmitting/receiving station to a first encryption/decryption (e/d) processor of a classical encryption system also having a second e/d processor. The method also includes exchanging quantum keys qi between first and second QKD stations in a QKD system and providing the quantum keys to the first and second e/d processors. The method also includes exchanging classical keys ci between first and second classical key exchange stations and providing the classical keys to the first and second e/d processors. The method also includes forming session keys ki in each e/d processor via ki=ci XOR qi, and forming an encrypted signal from the first plaintext signal at the first e/d processor using session keys ki formed in the first e/d processor. The method further includes forming a decrypted signal from the encrypted signal at the second e/d using the corresponding session keys ki formed in the second e/d processor, and then sending the second plaintext signal to the second transmitting/receiving station.

A fourth aspect of the invention is a method of forming a standards-compliant encryption system that utilizes QKD. The method includes forming a classical encryption link between two encryption/decryption (e/d) processors, symmetrically distributing quantum keys qi to the e/d processors, symmetrically distributing classical keys ci to the e/d processors, and then forming session keys ki via the operation ki=ci XOR qi. The encrypted key may then be used to encrypted and decrypt information sent between two transmitting/receiving stations.

### BRIEF DESCRIPTION OF THE DRAWINGS

FIG. 1 is schematic diagram of a prior art standards-compliant encryption system as implemented on a VPN;

FIG. 2 is a schematic diagram of a prior art encryption system that employs symmetric quantum key distribution to distribute a quantum key and send an encrypted signal over a VPN, and that is not standards-compliant;

FIG. 3 is a schematic diagram of an example of a standards-compliant QKD-based encryption system of the present invention for sending encrypted signals over a VPN; and

FIG. 4 is a schematic diagram of another example of a standards-compliant QKD-based encryption system of the present invention similar to that of FIG. 2, but that forms session keys ki from QKD-generated keys qi and classically generated keys ci via the function ki=ci XOR qi.

### DETAILED DESCRIPTION OF THE INVENTION

For the sake of illustration, in example embodiments discussed below, the standard being complied with is FIPS. Generally speaking, however, the standards to which the present invention applies are those that are not satisfied by a QKD system per se, but would be satisfied by one of the known classical encryption/decryption devices (processors) or techniques, such as Diffie-Hellman key exchange.

VPN Embodiment

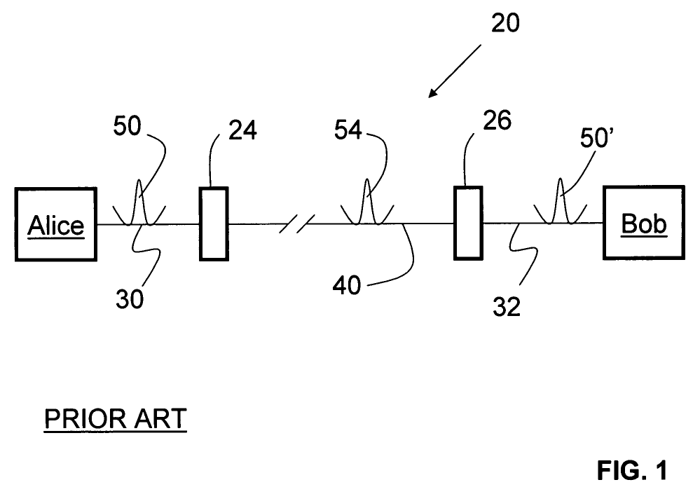

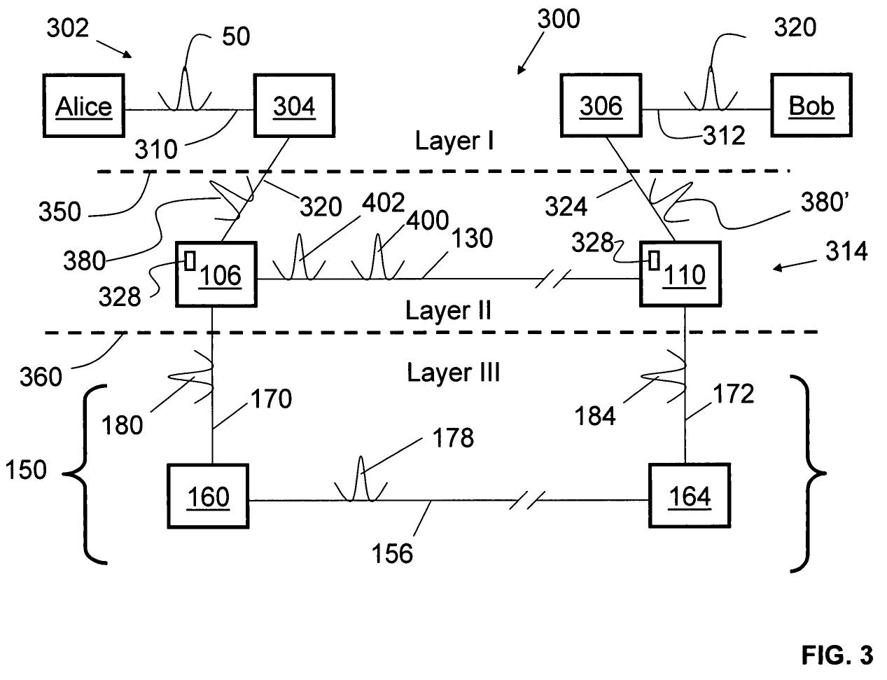

FIG. 3 is a schematic diagram of an example embodiment of a standards-compliant QKD-based encryption system 300 according to the present invention. System 300 of FIG. 1 is capable of sending encrypted signals over a VPN between first and second transmitting/receiving stations, referred to as Alice and Bob, respectively.

System 300 includes a standards-compliant VPN encryption system 302 similar to system 20 illustrated in FIG. 1, and which also includes VPN stations 304 and 306. Stations 304 and 306 may be, for example, two computers. Alice is connected to VPN station 304 via link 310. Bob is connected to VPN station 306 via link 312. In an example embodiment, links 310 and 312 are Ethernet links.

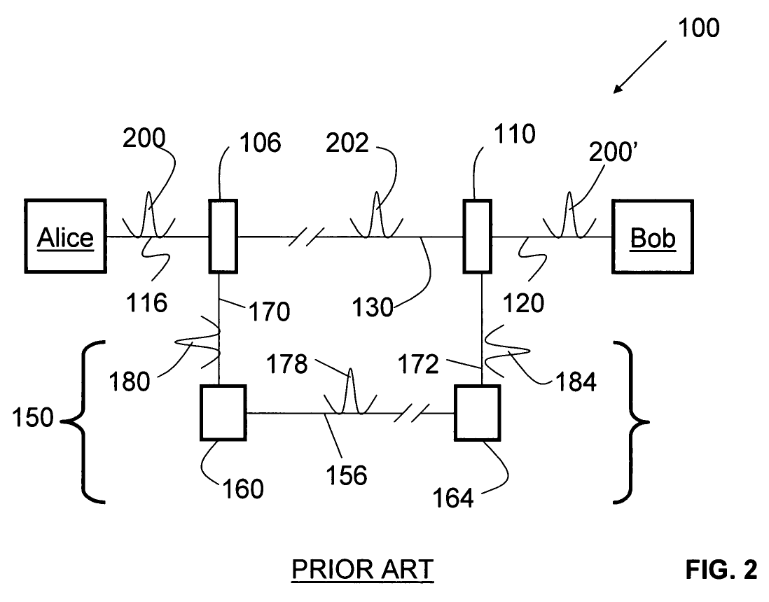

System 300 further includes a classical encryption system 314 that includes e/d processors 106 and 110. VPN station 304 is operatively connected to e/d processor 106 via VPN link 320 and VPN station 306 is operatively connected to e/d processor 110 via VPN link 324. The e/d processors 106 and 110 are operatively connected to one another via VPN link 130, as in FIG. 2. VPN links 320, 324 and/or 130 can be any one of a number of network-type links, such as those associated with a local area network (LAN), a metropolitan area network (MAN), wide area network (WAN), Internet, Intranet, Ethernet or public switched telephone network (PSTN).

In an example embodiment, e/d processors 106 and 100 each include a quantum key storage device 328 capable of storing quantum keys. An example quantum key storage device 328 includes non-volatile memory and circuitry sufficient to store and retrieve the quantum keys. In a preferred example embodiment, e/d processors 106 and 110 are included within VPN stations 304 and 306, respectively.

Classical encryption system 314 is, for example, a link encryptor. An example link encryptor is available from GDS, Inc., of Switzerland.

Also included as part of system 300 is the QKD system 150 of FIG. 2. QKD system 150 includes quantum channel 156 connecting the two QKD stations 160 and 164. QKD station 160 is operatively connected to e/d processor 106 via a connection 170, and QKD station 164 is operatively connected to e/d processor 110 via a connection 172.

Thus, system 300 includes three different operatively interconnected layers, identified in FIG. 3 as Layers I, II and Ill. The three layers are hierarchically distinguished in FIG. 3 by dashed lines 350 and 360. Layer I is the standards-compliant VPN layer, Layer II is the classical encryption layer, and Layer III is the QKD layer. Layers I-III are hierarchically arranged so that Layer I is the “highest” or uppermost level and Layer III is the “lowest” or bottom level.

In the operation of system 300, in Layer I Alice transmits a plaintext signal 50 over Ethernet section 30 to VPN station 304. Here, a “plaintext signal” means any non-encrypted signal, and is also referred to below and in the claims more generally as “information.” VPN station 304 receives plaintext signal 50 and converts plan text signal 50 to a VPN signal 380. Here, a “VPN signal” is any signal that travels over the VPN. Signal 380 is then transmitted to e/d processor 106 residing in Layer II.

Prior to, afterwards, or in synchrony therewith, in Layer III quantum key 178 is securely exchanged between QKD stations 160 and 164 using any one of a number of known quantum cryptographic methods. Once the key is securely exchanged (i.e., “quantum exchanged”), it is symmetrically distributed to e/d processors 106 and 110 via signals 180 and 184 from QKD stations 160 and 164, respectively. In an example embodiment of system 300, e/d processors 106 and 110 are included within QKD stations 160 and 164, respectively, for enhanced security.

VPN signal 380 is passed to e/d processors 106 and 110, where the signal is encrypted by a symmetric key encryption algorithm to form an encrypted signal 400. Examples of symmetric key encryption algorithms include AES or TDES that operate in a mode of operation approved by NIST, such as electronic codebook, cipher block chaining, cipher feedback, output feedback, counter mode, or one-time-pad encryption. VPN stations 304 and 306 also provide message authentication and data integrity functionality. If needed, e/d processors 106 and 110 can provide full functionality of a secure link, i.e., not just encryption/decryption. For example, e/d processors 106 and 110 can also add message authentication, and data packet control functionality on the top of VPN signal 380 when forming signal 400. Message authentication is accomplished, for example, by adding MAC values to signal 400 (e.g., in the form of data packets) sent over link 130. For that purpose, any known secure message authentication algorithm can be used (e.g., HMAC SHA-1).

The eld processors 106 and 110 can also add headers with data packet numbers, etc., to signal 400. As mentioned above, the keys for e/d processors 106 and 110 are provided by the QKD apparatus (Layer III). The e/d processors 106 and 110 include a key management method (protocol) that synchronizes the keys in each e/d processor and that performs key refreshing at select time intervals. For example, the (quantum) keys coming from QKD stations 160 and 164 (via signals 180 and 184) are split into two tables, one for each direction of communication. In an example embodiment, two more tables may be created for authentication. Each table contains, for example, a key ID, timestamp, or other information. The key ID (as well as some additional information) is then sent over channel 130 unencrypted as a signal 402, together with the encrypted signal (packet) 400, to provide key synchronization and refreshing functionality.

In this manner then, the e/d processors 106 and 110 are “interfaced” (i.e., operatively connected) to QKD stations 160 and 164, and to VPN stations 304 and 306.

Once the quantum key is distributed to e/d processors 106 and 110, it is used in Level II to classically encrypt VPN signal 380 at e/d processor 106 to form encrypted signal 400, as discussed above. This signal travels over Ethernet section 130 to e/d processor 110. At e/d processor 110, encrypted signal 400 is decrypted using the quantum key provided to e/d processor 110, thereby forming decrypted VPN signal 380′, which in turn is sent to VPN station 306. VPN station 306 converts VPN signal 380′ to a plaintext Ethernet signal 50′ and sends it to Bob over Ethernet section 312.

Because system 300 includes a standards-compliant VPN as Layer I and a classic encryption system in Layer II (which may also be standards-compliant, but need not be), system 300 as a whole is standards-compliant. The QKD system in Layer III operates transparently beneath standards-compliant Layer I and (optionally standards-compliant) layer 11. Nevertheless, Layer III provides system 300 with enhanced security as compared to the having only the classical encryption layer because the quantum transmission of the key. It is important to note that the presence of QKD Layer III does not render the system as a whole standards-noncompliant because it only serves to enhance the security of the system.

Session Key Embodiment

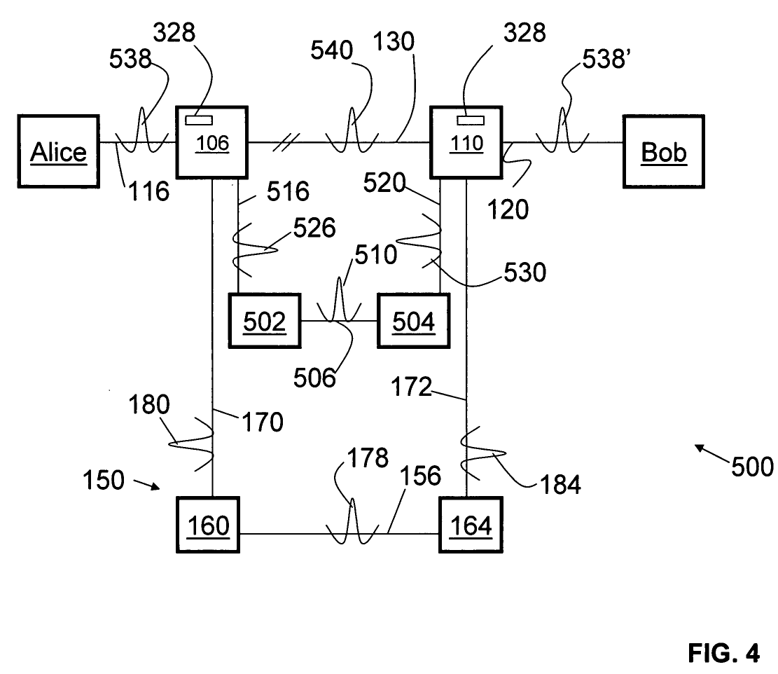

FIG. 4 is a schematic diagram of another example embodiment of a standards-compliant QKD-based encryption system 400 according to the present invention. For the purposes of the present invention, system 500 is considered as a VPN similar to VPN 100 shown in FIG. 2 and described above. System 500 additionally includes a classical encryption layer that includes classical key exchange stations 502 and 504 operably coupled to one another via a communication channel 506, such as the Internet. Classical key exchange stations 502 and 504 implement classical key exchange, such as Diffie-Hellman key exchange. Signal 510 represent the exchange of classical keys ci=c0, c1, c2 . . . cn.

Station 502 is coupled to e/d processor 106 via communication link (e.g., wire) 516, and station 504 is coupled to e/d processor 110 via communication link (e.g., wire) 520. The classic keys are symmetrically distributed to e/d processors 106 and 110 over respective links 516 and 520 via respective signals 526 and 530. Classical key exchange stations 502 and 502, e/d processors 106 and 110 and the corresponding links 516, 520 and 130 make up a classical encryption layer in this example embodiment.

Likewise, quantum keys qi=q0, q1, q2 . . . qn are exchanged between QKD stations 160 and 164 over quantum channel 156 via signal 178 using any one of a number of known quantum cryptographic methods. In an example embodiment, a block B of secure bits is exchanged, and block is split into 256 bit quantum keys q0, q1, q2, . . . qn. Once the key is securely exchanged, it is symmetrically distributed to e/d processors 106 and 110 via signals 180 and 184 from QKD stations 160 and 164, respectively, and stored in the respective e/d processors. QKD stations 160 and 164 along with quantum channel 156 make up the quantum encryption layer for this embodiment.

In each e/d processor 106 and 110, the classical keys ci and the quantum keys qi are XOR-ed, i.e., ci XOR qi to create keys ki, e.g., k0=c0 XOR q0, k1=c1 XOR q1, k2=c2 XOR q2, . . . kn=cn XOR qn. Keys ki are referred to herein as the “session keys.”

The session keys ki are then used by e/d processors 106 and 110 to communicate encrypted information between Bob and Alice. For example, keys ki can be used as IP security (“IPSec”) session keys to encrypt the plaintext IP signal 538 from Alice at e/d processor 106 to form encrypted signal 540.

Signal 540 is sent over link 130, where it is decrypted at e/d processor 110 to form decrypted signal 538′, which is then sent to Bob over link 130. In this scenario, the classical keys ci can be provided by IKE, which is a part of IPSec.

In an example embodiment, classical and quantum keys ci and qi are flipped at a preset rate. In an example embodiment, the flipping rate for the keys ci and qi are different.

Because the classical keys ci are generated by standards-compliant method, system 500 as a whole is standards-compliant, e.g., FIPS-compliant. This is because the level of security of the keys never falls below that of standards-compliant classical encryption.

While the present invention has been described in connection with preferred embodiments, it will be understood that it is not so limited. On the contrary, it is intended to cover all alternatives, modifications and equivalents as may be included within the spirit and scope of the invention as defined in the appended claims.

1. A standards-compliant QKD-based encryption system, comprising:
first and second transmitting/receiving stations operatively coupled to respective first and second operatively coupled encryption/decryption (e/d) processors;
first and second operatively coupled QKD stations respectively operatively connected to the first and second e/d processors and adapted to exchange quantum keys qi between the first and second QKD stations and provide the quantum keys to the first and second e/d processors;
first and second operatively coupled standards-compliant classical key exchange stations respectively operatively connected to the first and second e/d processors and adapted to exchange classical keys ci and provide the classical keys to the first and second e/d processors; and
wherein the e/d processors are adapted to receive a signal from one of the transmitting/receiving stations, encrypt the signal using session keys ki formed in the e/d processors via the operation ki=ci XOR qi, and transmit the encrypted signal to the other transmitting/receiving station.

2. The system of claim 1, wherein the standard is the federal information processing standard (FIPS).

3. The system of claim 1, wherein the signal is a plaintext signal.

4. The system of claim 1, wherein the first and second e/d processors are operably connected to one another by an Ethernet section.

5. The system of claim 1, wherein the first and second transmitting/receiving stations are computers.

6. The system of claim 1, wherein the first and second e/d processors each include a quantum key storage device for storing classical and/or quantum keys.

7. A standards-compliant QKD-based encryption system, comprising:
a standards-compliant classical encryption layer having first and second operably coupled classical key exchange stations and operatively coupled to first and second encryption/decryption (e/d) processors;
a QKD layer operatively connected to the first and second e/d processors; and
wherein the QKD layer provides quantum keys qi to the e/d processors, the classical key exchange stations provide classical keys ci to the e/d processors, and wherein the e/d processors form session keys ki via the operation ki=ci XOR qi.

8. The system of claim 7, further including first and second transmitting/receiving stations respectively coupled to the first and second e/d processors.

9. A standards-compliant QKD-based encryption system, comprising:
a standards-compliant VPN layer;
a classical encryption layer operatively connected to the standards-compliant VPN layer;
a QKD layer operatively connected to the classical encryption layer; and
wherein the QKD layer provides a quantum key to the classical encryption layer so that the classical encryption layer is capable of encrypting information from the standards-compliant VPN layer using the quantum key.

10. The system of claim 9, wherein the classical encryption layer includes first and second encryption/decryption (e/d) processors, and wherein:
the QKD layer includes first and second QKD stations respectively operatively coupled to the first and second e/d processors and adapted to symmetrically distribute quantum keys qi to the first and second e/d processors.

11. The system of claim 10, wherein:
the classical encryption layer includes first and second classical key exchange stations respectively coupled to the first and second e/d processors and adapted to symmetrically distribute classical keys ci to the first and second e/d processors; and
wherein the first and second e/d processors are adapted to form session keys ki via the operation ki=ci XOR qi.

12. A standards-compliant encryption system comprising:
first and second transmitters/receivers operatively connected through a standards-compliant VPN;
a classical encryption system operatively connected to the standards-compliant VPN and to a QKD system; and
wherein the QKD system provides a quantum key to the classical encryption system, which then uses the quantum key to encrypt and decrypt a plaintext signal input from one of the first and second transmitters/receivers.

13. The system of claim 12, wherein the classical encryption system is standards-compliant.

14. The system of claim 13, wherein the standard is the federal information processing standard (FIPS).

15. A standards-compliant encryption system comprising:
first and second transmitters/receivers operatively connected through a standards-compliant classical encryption system and operatively connected to a QKD system; and
wherein the QKD system and classical encryption system respectively provide classical keys ci and quantum keys qi to respective encryption/decryption (e/d) processors, which then form session keys ki via the operation ki=ci XOR qi, and wherein the e/d processors use the session keys to encrypt and decrypt a plaintext signal input from one of the first and second transmitters/receivers.

16. A method of forming a standards-compliant QKD encryption system using a standards-compliant VPN, the method comprising:
forming a classical encryption link by operatively connecting first and second operatively connected encryption/decryption (e/d) processors to respective first and second VPN stations of the standards-compliant VPN; and
operatively connecting first and second operatively connected stations of a QKD system to the first and second e/d processors, respectively, the first and second QKD stations capable of exchanging quantum keys qi and symmetrically distributing the quantum keys to the first and second e/d processors.

17. The method of claim 16, including operatively connecting first and second transmitting/receiving stations to the first and second VPN stations, respectively, wherein the first and second transmitting/receiving stations are adapted to transmit and/or receive plaintext signals.

18. The method of claim 16, including operatively connecting the first and second e/d processors by an Ethernet section.

19. The method of claim 16, including:
symmetrically distributing to the first and second e/d processors classical keys ci;
forming session keys ki in each of the first and second e/d processors via the operation ki=ci XOR qi.

20. The method of claim 19, further including using the session keys ki to encrypt plaintext signals sent to one of the e/d processors.

21. A method of transmitting an encrypted signal between first and second transmitting/receiving stations, comprising:
sending a first plaintext signal from the first transmitting/receiving station to a first encryption/decryption (e/d) processor of a classical encryption system also having a second e/d processor;
exchanging quantum keys qi between first and second QKD stations in a QKD system and providing the quantum keys to the first and second e/d processors;
exchanging classical keys ci between first and second classical key exchange stations and providing the classical keys to the first and second e/d processors;
forming session keys ki in each e/d processor via ki=ci XOR qi;
forming an encrypted signal from the first plaintext signal at the first e/d processor using session keys ki formed in the first e/d processor;
forming a decrypted signal from the encrypted signal at the second e/d using the corresponding session keys ki formed in the second e/d processor; and
sending the second plaintext signal to the second transmitting/receiving station.

22. A method of forming a standards-compliant encryption system that utilizes QKD, comprising:
symmetrically distributing quantum keys qi and classical keys ci to operably coupled first and second e/d processors; and
forming in the first and second e/d processors session keys ki via the operation ki=ci XOR qi.

23. The method of claim 22, further including:
using the session keys to encrypt signals transmitted between first and second transmitting/receiving stations respectively coupled to the first and second e/d processors.
